(19) United States
(12) Patent Application Publication
(10) Pub. No.: US 2026/0158499 A1
(43) Pub. Date: Jun. 11, 2026

(54) ARRANGEMENT FOR THE SELF-SUFFICIENT REGULATION OF LIQUID LEVELS IN A PLASTICS RECYCLING PROCESS

(71) Applicant: GRANNEX GMBH & CO. KG, Osnabrück (DE)

(72) Inventors: Markus BÖRGER, Osnabrück (DE); Andreas STOLZENBERG, Schwanewede (DE)

(21) Appl. No.: 18/709,885

(22) PCT Filed: Feb. 8, 2023
(86) PCT No.: PCT/DE2023/100102

§ 371 Date: May 14, 2024

(51) Int. Cl. B03B 13/00; B01F 23/53; B01F 27/80; B01F 35/221; B01F 101/00; B03B 5/34

(52) U.S. Cl. CPC B03B 13/00; B01F 23/53; B01F 27/80; B01F 35/2212; B03B 5/34; B01F 2101/2805

(57) ABSTRACT

An arrangement for the self-sufficient regulation of liquid levels in a plastic recycling process, having at least one compensation container and at least one stirring container, wherein the compensation container and the stirring container are filled with a process water so that the compensation container has a first liquid level and the stirring container has a second liquid level, wherein the at least one compensation container is fluidically connected to the stirring container so that the process water can flow freely between the compensation container and the stirring container, whereby the first and the second liquid level of the at least one compensation container and of the at least one stirring container are the same.

### CROSS-REFERENCE TO RELATED APPLICATIONS

This application is a U.S. National Phase Application under 35 U.S.C. 371 of International Application No. PCT/DE 2023/100102, filed on Feb. 8, 2023. The entire disclosure of the above application is incorporated herein by reference.

### BACKGROUND

This section provides background information related to the present disclosure which is not necessarily prior art.

### TECHNICAL FIELD

The invention relates to an arrangement for the self-sufficient regulation of liquid levels in a plastics recycling process,

### DISCUSSION

Increasing amounts of plastics waste pose enormous challenges to our society in the coming years. In 2019, around 5.35 million tons of post-consumer plastics waste were generated in Germany. Of this, only 1.33 million tons were fed to a material utilization in processing plants within Germany. From this, in turn, only 1.03 million tons of output were generated in a quality which is suitable for re-use in the plastics processing industry. This corresponds to a rate of somewhat over 19%. The truth about the performance of Germany in plastics recycling and recycling is correspondingly sobering.

As of today, Germany does not have the necessary recycling infrastructure in order to economically and technically process the amounts of plastics waste generated here into high-quality recycles. Many processing plants today do not correspond to the state of the art, are outdated and are economically very weakly based.

Increasing amounts of plastics waste, intensified national and international legislation on licensing procedures and for increasing utilization rates and the use of recycles and waste import and export restrictions pose enormous challenges to the EU Member States and, in particular, plastics recycling companies in the coming years. Investments in processing capacities and, in particular, the development of new processing methods for solving the described challenges and problems are urgently required.

One of the greatest challenges for plastics recyclers is highly contaminated plastics waste mixtures. With existing recycling processes and plants, these fractions are currently only very limited in terms of material processing. A large part of these wastes is therefore currently finding their way into thermal utilization. In addition, a large part of the recycles produced does not enable stable plastics processing processes on account of qualitative deficits and therefore only rarely replaces new goods in a sustainable manner in technically demanding plastics products.

Modern processing processes for plastics waste have a multiplicity of individual process steps, in which an initially highly contaminated plastics waste mixture, which can have a wide variety of plastic types in variable composition, is washed or cleaned, comminuted and finally separated with high precision according to the different plastics types. In this case, high process reliability and stability is indispensable for efficient and very precise separation of the different plastics fractions. One aspect relates to the very continuous provision of a specific volume flow of the plastics waste/process water mixture, which is required, for example, for separating the individual plastics fractions, for example by means of a hydrocyclone.

### SUMMARY

This section provides a general summary of the disclosure and is not a comprehensive disclosure of its full scope or all of its features.

It is therefore one aspect of the invention to provide an arrangement for regulating liquid levels in different containers in a plastics recycling process, which arrangement has a lower technical outlay and can be operated reliably and without maintenance.

Accordingly, it is provided that the arrangement has at least one compensation container and at least one stirring container, wherein the compensation container and the stirring container are filled with a process water so that the compensation container has a first liquid level and the stirring container has a second liquid level, wherein the at least one compensation container is fluidically connected to the stirring container so that the process water can flow freely between the compensation container and the stirring container, whereby the first and the second liquid level of the at least one compensation container and of the at least one stirring container are the same.

The compensation container can be an interim reservoir in which process water is collected before it is discharged to one, expediently a plurality of, subsequent stirring containers. The compensation container can accordingly have a larger volume, in particular a larger average area, than the stirring container. The cross section of the stirring container and/or of the compensation container can be round. The liquid level can be set such that it is above half, preferably above two thirds, of the height of the compensation container and/or of the stirring container. The compensation container can be fluidically connected to the at least one stirring container such that the water can flow freely, that is to say unhindered, between these containers. By virtue of the fact that the process water is a substantially homogeneous liquid and the force of gravity and the ambient air pressure are the same in both containers, the levels in both containers always level off to the same height.

In particular, it can be provided that the process water contains ground material of a plastics waste mixture which have an inhomogeneous bulk density. 2D materials such as, for example, films made of LD-PE have on average a lower bulk weight than 3D materials such as, for example, hollow plastics bodies made of HD-PE. That is to say, the bulk density correlates with the 2D or the 3D proportion in the plastics waste mixture. The bulk density can be, for example, between 10 grams/liter in the case of a very high 2D material proportion and 475 grams/liter in the case of a very high 3D material proportion.

It can be provided that the at least one compensation container and the at least one stirring container each have at least one ventilation opening above the respective liquid level. For example, both containers can each be open at the top.

It is conceivable that the compensation container further has an inlet via which process water flows into the compensation container, and the stirring container further has an outlet via which process water flows out of the stirring container.

It can further be provided that the arrangement has at least two or more stirring containers fluidically connected to the compensation container, wherein the second and the optionally further stirring containers each have a liquid level which is the same as the first and the second liquid level. The advantage of the invention is, in particular, that a complex monitoring of the filling level heights with the control circuits connected thereto with control, pipeline and valves does not have to be provided separately at each of the stirring containers. Instead, the filling level monitoring can be limited to the compensation container. The saving becomes greater with each stirring container connected to the compensation container.

In particular, the at least two stirring containers can be fluidically connected to the compensation container via a respective pipeline. Alternatively, the stirring containers can also be connected to one another via a pipeline lying below the level.

So that the first and the second liquid level of the at least one compensation container and of the at least one stirring container are the same, it is clear that the connections of the pipelines each open into the respective container below the first and/or the second predetermined liquid level.

It can be provided that the containers, stirring container and compensation container, each have the same container height and the connections each open into the respective container at a height between half and two thirds of the container height. The pipelines can further each be flanged tangentially to the stirring containers via their connections on the stirring container side. The process water can thereby flow into the respective stirring container without generating a counter-flow to the stirring direction if the stirring direction is selected accordingly. For this purpose, the stirring containers can each have a stirring device which rotates about a substantially vertical axis. It can be provided that the stirring direction is selected such that it corresponds to the inflow direction of the process water flowing in from the compensation container.

It can be provided that the compensation container has a level detection device and a control device which is configured to keep the filling level in the compensation container at a constant level. The level detection device can be implemented, for example, by a float or overflow. In this case, the control device can be connected to the level detection device via a data connection and control an actuator of a valve arranged at the inlet, via which the liquid level in the compensation container can be regulated.

Furthermore, it can be provided that at least one centrifugal force separator such as, for example, a hydrocyclone is arranged downstream of the stirring containers in terms of process technology. This hydrocyclone can have an inlet which is fluidically coupled to an outlet of a stirring container. The at least one hydrocyclone can be configured to separate the ground material of the plastics waste mixture depending on a predeterminable density separation cut. For this purpose, the hydrocyclone can have the mentioned inlet for process water and further a first outlet for a light fraction and a second outlet for a heavy fraction.

The density-based separation of the plastics waste mixture can be repeated several times in order to enrich a desired substance fraction. It can therefore further be provided that the process water comprising the plastics mixture passes through a plurality of hydrocyclones in succession. The concentration of the ground material is greater in the outlet for particles having a higher specific density of the hydrocyclone than in the outlet for particles having a lower specific density. The density of the second stage of the hydrocyclone can therefore be set incrementally smaller or greater than the density of the first stage. The hydrocyclone has an upper, cylindrical segment with a tangential inlet, and further a lower, conical segment with an underflow or an apex nozzle. The hydrocyclone can further have a vortex finder or an overflow nozzle, in the form of a dip tube, which projects axially from above into the interior of the cyclone and ends below the tangential inlet. As a result of the tangential entry into the cylindrical segment, the liquid is forced onto a circular path and flows downward in a downwardly directed vortex. As a result of the tapering in the conical segment, there is a displacement of volume inward and a build-up in the lower region of the cone, which leads to the formation of an inner, upwardly directed vortex which escapes through the vortex finder or the overflow opening. The aim is the separation of the specifically heavier fraction (for example solid) on the wall of the cyclone and therefore the discharge through the underflow, while the specifically lighter fraction escapes through the overflow. The hydrocyclone can have a vertical flow which is directed downward in the outer region (primary vortex) and upward in the inner region (secondary vortex). The particles collecting in these flows are therefore fed either to the overflow opening or to the underflow opening.

It can further be provided that the predeterminable density for separating the plastics waste mixture flow can be set between 1 and 1.05kg/dm3.

It can further be provided that the separation into two fractions comprises the enrichment of a light fraction in at least one first hydrocyclone and the enrichment of a heavy fraction in at least one second hydrocyclone. The hydrocyclones can be connected in series here. It can be provided, for example, that a first hydrocyclone performs a first separating cut into a light fraction and a heavy fraction, and that a further light fraction hydrocyclone receiving and further enriching the light fraction is provided and/or a further heavy fraction hydrocyclone receiving and further enriching the heavy fraction is provided. The heavy fraction hydrocyclone can be a flat-bottom hydrocyclone.

Further areas of applicability will become apparent from the description provided herein. The description and specific examples in this summary are intended for purposes of illustration only and are not intended to limit the scope of the present disclosure.

### DRAWINGS

The drawings described herein are for illustrative purposes only of selected embodiments and not all possible implementations and are not intended to limit the scope of the present disclosure.

Further details of the invention are explained with reference to the following figures. In the figures:

FIG. 1 shows a schematic plan view of an embodiment of the arrangement according to the invention; and

FIG. 2 shows a schematic side view of an embodiment of the arrangement according to the invention.

### DETAILED DESCRIPTION

Example embodiments will now be described more fully with reference to the accompanying drawings.

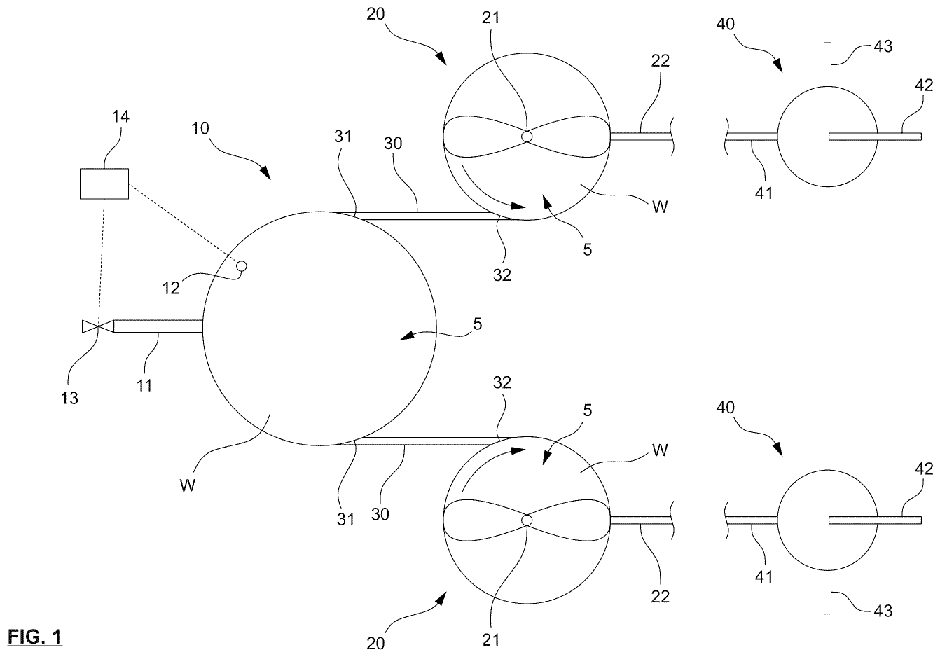

FIG. 1 shows a schematic plan view of an embodiment of the arrangement according to the invention. This has a compensation container 10, which has an inlet 11, which can be regulated via a valve 13. The compensation container 10 has a level detection device 12 for continuous level monitoring. This is coupled via a data connection to a control unit 14, which is in turn configured to control an actuator of the valve 13 in order to open or close the latter, depending on whether the level P1 of the process water W in the compensation container 10 lies below or above a setpoint value. The compensation container 10 is open at the top and therefore has an opening 5, via which the process water W in the compensation container 10 is in contact with the ambient air. In the embodiment shown, two stirring containers 20, which are fluidically connected to the compensation container 10 via respective pipelines 30, are connected to the compensation container. The pipelines have a first connection 31 on the compensation container side and a second connection 32 on the stirring container side, wherein both connections 31, 32 lie below the liquid levels P1, P2 of the compensation container 10 and of the stirring containers 20. The connections 31, 32 are each flanged tangentially laterally to the compensation container 10 or to the stirring containers 20. The stirring containers 20 are likewise filled with process water W, wherein the levels P1 and P2 are the same. The stirring containers 20 are also open at the top and accordingly have an opening 5. The stirring containers 20 further each have a stirring device 21, which has a vertical axis of rotation. The direction of rotation of the stirring devices 20 is in each case selected such that the process water W flowing into the respective stirring container 20 through the pipeline 30 flows in the stirring direction. The stirring containers 20 further each have an outlet 22, downstream of which in each case a hydrocyclone 40 is arranged, in order to separate the plastics mixture contained in the process water along a predetermined density separation cut into a light fraction 42 and a heavy fraction 43. The process water W flows into the hydrocyclone through an inlet 41.

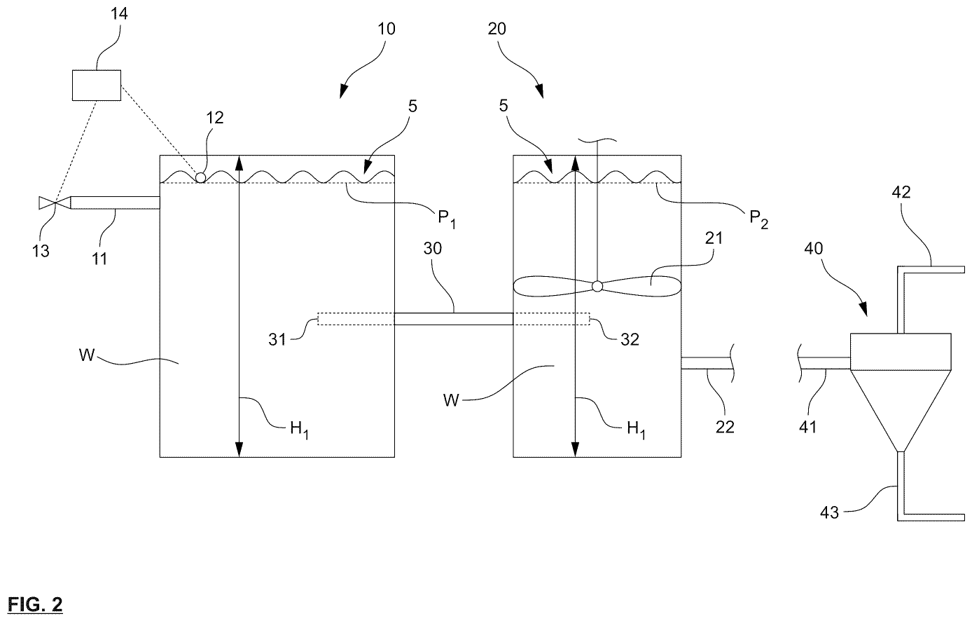

FIG. 2 shows a schematic side view of the arrangement from FIG. 1. It can be seen that the liquid level P1 in the compensation container 10 and the liquid level P2 in the stirring container 20 are the same. This is achieved in that the connection 31 of the connecting tube 30 on the compensation container 10 and the connection 32 on the stirring container 20 open into the respective containers below the liquid levels P1, P2 and the containers 10, 20 are further each open at the top or have an opening 5. In the exemplary embodiment shown, the containers 10, 20 each have the same height H1. The inlet 11 of the compensation container 10 lies above the connecting tube 30, the outlet 22 of the stirring container 20 lies below the connecting tube 30. The process water W first flows through the inlet 11, depending on the position of the valve 13, into the compensation container 10. The process water W flows through the connecting tube 30 from the compensation container 10 into the one or more stirring containers 20. There, the process water is stirred by means of the stirring device 21 before it flows out of the outlet 22 from the stirring container 20 in the direction of the hydrocyclone 40. The hydrocyclone 40 for obtaining polymers in the course of a density-based separation of the plastics waste mixture is arranged downstream of the stirring container 20 and is at least indirectly connected thereto. The mixture of process water W and the plastics waste mixture is fed to the hydrocyclone 40 and has, for example, PE, PP, PS, PET, PP-T, ABS and other constituents. In the example shown, the hydrocyclone 40 is a conical hydrocyclone and divides the plastics waste mixture into a light fraction 42 and a heavy fraction 43. The hydrocyclone 40 separates the light fraction 41 and the heavy fraction 43, for example at a density cut of 1 kg/dm³. The light fraction 41 therefore contains, for example, PE and PP. The heavy fraction 43 correspondingly comprises the rest of the plastics waste mixture, namely PS, PET, PP-T, ABS and the other constituents. The light fraction 41 can then be fed to further steps (not shown) of the process, and the heavy fraction 43 can be fed to a second hydrocyclone (not shown), which can be designed as a flat-bottom hydrocyclone. A density separation cut of up to 1.05 kg/dm³ can then take place therein, for example, so that a second light fraction can be separated from a second heavy fraction in the second hydrocyclone. The second light fraction can comprise PS, PP-T and ABS, the second heavy fraction PET and the other constituents. All fractions can then be fed to the further process steps separately from one another after passing through the hydrocyclones.

The features of the invention disclosed in the above description, in the drawings and in the claims can be essential both individually and in any combination for the realization of the invention.

The foregoing description of the embodiments has been provided for purposes of illustration and description. It is not intended to be exhaustive or to limit the disclosure. Individual elements or features of a particular embodiment are generally not limited to that particular embodiment, but, where applicable, are interchangeable and can be used in a selected embodiment, even if not specifically shown or described. The same may also be varied in many ways. Such variations are not to be regarded as a departure from the disclosure, and all such modifications are intended to be included within the scope of the disclosure.

1-15. (canceled)

16. An arrangement for the self-sufficient regulation of liquid levels in a plastics recycling process, comprising:
at least one compensation container and at least one stirring container which has a stirring device which rotates about a substantially vertical axis, wherein the compensation container and the stirring container are filled with a process water, so that the compensation container has a first liquid level and the stirring container has a second liquid level, wherein the at least one compensation container is fluidically connected to the stirring container, so that the process water can flow freely between the compensation container and the stirring container, as a result of which the first and the second liquid level of the at least one compensation container and of the at least one stirring container are the same, wherein at least one hydrocyclone is arranged downstream of the stirring containers in terms of process technology.

17. The arrangement according to claim 16, wherein the process water contains ground material of a plastics waste mixture having an inhomogeneous bulk density.

18. The arrangement according to claim 16, wherein the at least one compensation container and the at least one stirring container each have at least one vent opening above the respective liquid level.

19. The arrangement according to claim 16, wherein the compensation container further has an inlet via which process water flows into the compensation container, and the stirring container further has an outlet via which process water flows out of the stirring container.

20. The arrangement according to claim 16, which has at least two or more stirring containers fluidically connected to the compensation container, wherein the second and the optionally further stirring containers each have a liquid level which is equal to the first and the second liquid level.

21. The arrangement according to claim 20, wherein the at least two stirring containers are fluidically connected to the compensation container via a respective pipeline.

22. The arrangement according to claim 21, wherein the connections of the pipelines each open into the respective container below the first and/or the second predetermined liquid level.

23. The arrangement according to claim 21, wherein the containers each have the same container height and the connections each open into the respective container at a height between half and two thirds of the container height.

24. The arrangement according to claim 21, wherein the pipelines are each flanged tangentially to the stirring containers via their connections on the stirring container side.

25. The arrangement according to claim 16, wherein the compensation container has a level detection device and a control device which is configured to keep the filling level in the compensation container at a constant level.

26. The arrangement according to claim 25, wherein the control device is connected to the level detection device via a data connection and controls an actuator of a valve arranged at the inlet, via which the liquid level in the compensation container can be regulated.

27. The arrangement according to claim 16, wherein the at least one hydrocyclone is configured to separate the ground material of the plastic waste mixture depending on a predeterminable density separation cut.

28. The arrangement according to claim 16, wherein the hydrocyclone has an inlet for process water, a first outlet for a light fraction and a second outlet for a heavy fraction.
